(19) United States
(12) Patent Application Publication
(10) Pub. No.: US 2020/0298531 A1
(43) Pub. Date: Sep. 24, 2020

(54) POLYURETHANE-BASED INSULATION BOARD

(71) Applicant: Dow Global Technologies LLC, Midland, MI (US)

(72) Inventors: Luigi Bertucelli, Correggio (IT); Elena Ferrari, Correggio (IT); Giuseppe Vairo, Correggio (IT)

(73) Assignee: Dow Global Technologies LLC, Midland, MI (US)

(21) Appl. No.: 16/766,862

(22) PCT Filed: Nov. 7, 2018
(86) PCT No.: PCT/US2018/059522

§ 371 Date: May 26, 2020

(30) Foreign Application Priority Data
Nov. 28, 2017 (IT) 102017000136462

(51) Int. Cl. B32B 9/04; C08G 18/40; C08G 18/65; C08K 7/24; C08K 3/04; C08K 3/40; B32B 17/06; B32B 7/12; E04B 1/76

(52) U.S. Cl. CPC B32B 9/046; C08G 18/40; C08G 18/65; C08K 7/24; C08G 2101/0016; C08K 3/40; B32B 17/067; B32B 7/12; E04B 1/7625; C08K 3/04

(57) ABSTRACT

External thermal insulation composite systems described herein include a concrete or masonry wall and a multilayer thermal insulation board on the concrete or masonry wall. The multilayer thermal insulation board includes a high density polyurethane layer having a first density from 100 kg/m³ to 2000 kg/mm³ according to ASTM D 1622 and a rigid polyurethane foam having a second density of less than 100 kg/m³ according to ASTM D 1622.

### FIELD

Embodiments of the present disclosure are generally related to polyurethane-based insulation boards, and are more specifically related to polyurethane-based insulation boards including a high density polyurethane layer and a rigid polyurethane foam layer.

### BACKGROUND

Insulation systems for external walls, such as concrete or masonry walls, have been proposed. The combination of the thermal insulation product applied on the outer face of the external wall and faced by a rendering system is referred to as an external thermal insulation composite system (ETICS). External thermal insulation composite systems are often the preferred choice in construction over other solutions, both for new dwellings and for refurbishment of existing building stock.

Most common external thermal insulation composite systems employ expanded polystyrene (EPS) as in insulating material. However, polyurethane may typically provide certain favorable properties over lower cost alternatives, such as thermal insulation, strength, and limited water uptake. Accordingly, it is proposed to combine polyurethane based insulation boards with external walls in external thermal insulation composite systems.

### summary

According to one or more embodiments herein, an external thermal insulation composite system includes a concrete or masonry wall and a multilayer thermal insulation board on the concrete or masonry wall. The multilayer thermal insulation board includes a high density polyurethane layer having a first density from 100 kg/m³ to 2000 kg/m³ according to ASTM D 1622 and a rigid polyurethane foam having a second density of less than 100 kg/m³ according to ASTM D 1622.

According to another embodiment, a method of preparing an external thermal insulation composite system is provided. The method comprises: providing a concrete or masonry wall; providing a multilayered thermal insulation board that comprises a high density polyurethane layer having a density from 100 kg/m³ to 2000 kg/m³ and a rigid polyurethane foam layer having a density less than 100 kg/m³; attaching the multilayered thermal insulation board to an external surface of the concrete or masonry wall using an adhesive or mechanical fixing device; and applying a reinforced coating with embedded glass fiber mesh reinforcement on the multilayered thermal insulation board attached to the external surface of the concrete or masonry wall. In a further embodiment, the multilayered thermal insulation board may be prepared according to a continuous process, the continuous process comprising: providing a first facing as a lowermost layer; dispensing a first reaction mixture to form the at least one high density polyurethane layer on a surface of the first facing; dispensing a second reaction mixture to form the rigid polyurethane foam layer on the forming high density polyurethane layer; providing a second facing layer on the rigid foam polyurethane layer as an uppermost layer; and allowing the multilayered thermal insulation board to cure between two spaced apart, opposed forming conveyors.

### BRIEF DESCRIPTION OF THE DRAWINGS

FIG. 1 illustrates an exemplary external thermal insulation composite system; and

FIG. 2 shows an exemplary multilayer thermal insulation board including a high density polyurethane layer and a rigid polyurethane foam.

### DETAILED DESCRIPTION

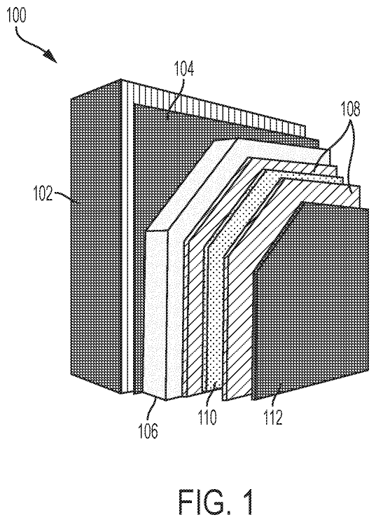

Referring to FIG. 1, an external thermal insulation composite system 100 may include an external wall 102, such as a concrete or masonry wall. Masonry, also known as stonework or brickwork, may include relatively large units (stone, bricks, blocks, etc.) that are bound together by mortar into a monolithic structure. Concrete is made of cement, aggregates and water and may be set into place to create a structure without units.

The system may further include an adhesive 104 disposed directly on an outer surface of the external wall 102. The adhesive 104 may be placed between the outer surface of the external wall 102 and an insulation component 106. In various embodiments, the adhesive 104 may be a flexible adhesive, such as a foam adhesive, silicone adhesive, hot melt adhesive, or cold melt adhesives. In some particular embodiments, the adhesive may be a polyurethane foam adhesive, such as the polyurethane foam adhesive commercially available as Insta-Stik™ from The Dow Chemical Company (Midland, Mich.). Although various embodiments described herein describe an adhesive 102 for attaching the insulation component 106 to the external wall 102, it is contemplated that the insulation component 106 may be attached to the external wall 102 in other ways, such as through the use of a mechanical fixing device.

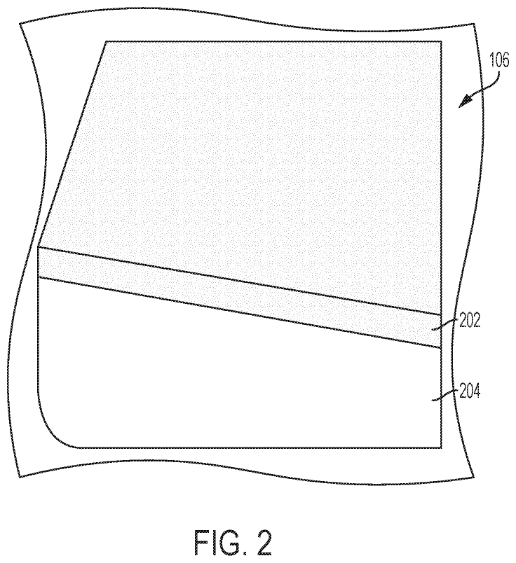

According to various embodiments, the insulation component 106 may be a multilayer thermal insulation board that includes a high density polyurethane layer 202 having a first density from 100 kg/m³ to 2000 kg/m³ according to ASTM D 1622 and a rigid polyurethane foam 204 having a second density of less than 100 kg/m³ according to ASTM D 1622 (shown in FIG. 2), as will be described in greater detail below. In some embodiments, the insulation component 106 may be oriented so that the high density polyurethane layer 202 is positioned toward the render, although in other embodiments, the high density polyurethane layer 202 may be positioned toward the outer face of the external wall 102 to be insulated.

Still referring to FIG. 1, the external thermal insulation composite system 100 may further include one or more base coat layers 108 separated from the adhesive 104 by the insulation component 106. Although the embodiment depicted in FIG. 1 includes two base coat layers 108, it is contemplated that in some embodiments, the external thermal insulation composite system 100 may include three or more base coat layers, one base coat layer, or even no base coat layers.

The external thermal insulation composite system 100 depicted in FIG. 1 also includes a reinforcing mesh 110 positioned between the two base coat layers 108. In various embodiments, the reinforcing mesh 110 may be a polymer coated glass-fiber mesh fabric. The glass-fiber mesh fabric may, in some particular embodiments, have a weight of 100 to 220 g/m, or a weight of 140 to 180 g/m.

Finally, a top coat 112 is positioned on the external thermal insulation composite system 100. The top coat may include, by way of example and not limitation, grained and scratched renders, decorative panels, brick effects, or actual brick slips. Other types of top coats are contemplated, depending on the particular embodiment.

Having generally described the external thermal insulation composite system 100, the insulation component 106 will now be described in greater detail, with reference to FIG. 2. As provided above, in various embodiments, the insulation component 106 is a multilayer thermal insulation board that includes a high density polyurethane layer 202 having a first density from 100 kg/m³ to 2000 kg/m³ according to ASTM D 1622 and a rigid polyurethane foam 204 having a second density of less than 100 kg/m³ according to ASTM D 1622. As used herein, the term “polyurethane” encompasses polyurethane, polyurethane/polyurea, and polyurethane/polyisocyanurate materials. In various embodiments, the insulation component 106 may include at least one facing layer.

### High Density Polyurethane Layer

In various embodiments, the high density polyurethane layer may be formed from a polymer matrix formed by reacting an isocyanate-reactive component with an isocyanate component. In particular, the polymer matrix may include urethane groups, isocyanurate groups, and/or urea groups.

The isocyanate-reactive component includes one or more polyols. In various embodiments the polyol may be a polyether polyol formed using initiators such as propylene glycol, glycerine, trimethylpropane, sucrose, sorbitol, novolac, or toluenediamine. Polyols suitable for use in the high density layer include, by way of example and not limitation, those commercially available under the tradename VORANOL™ from The Dow Chemical Company (Midland, Mich.), examples of which include VORANOL™ CP 4702 (a polyether polyol formed by adding propylene oxide and ethylene oxide to a glycerine starter and having a nominal functionality of 3 and an EW of approximately 1580) and VORANOL™ P1010 (a polyether polyol formed by adding propylene oxide to a propylene glycol starter and having a nominal functionality of 2 and an EW of approximately 508). Other example polyols include VORANOL™ RN490 and VORANOL™ RH360 (polyether polyols formed by adding propylene oxide to sucrose and glycerine and having an average functionality greater than 4 and an EW of 115 and 156, respectively), VORANOL™ RN482 (polyether polyol formed by adding propylene oxide to sorbitol and having a nominal functionality of 6 and an EW of 115), TERCAROL™ 5903 (polyether polyol formed by adding propylene oxide to toluenediamine and having a nominal functionality of 4 and an EW of 127), all available from The Dow Chemical Company (Midland, Mich.).

Other suitable polyols include polyester polyols such as aromatic polyester polyols. The polyester polyol may include from 30 wt % to 40 wt % terephthalic acid, from 5 wt % to 10 wt % of diethyleneglycol, and from 50 wt % to 70 wt % of polyethylene glycol. Examples of commercially available polyester polyols, made of phtalic anhydride and suitable for use include those available under the tradename STEPANPOL™ (available from Stepan Company), examples of which include STEPANPOL™ 3152, STEPANPOL™ 2352, and STEPANPOL™ PS 70L.

Other types of polyols may be used in addition to those provided above. For example, aliphatic polyester polyols, aliphatic or aromatic polyether-carbonate polyols, aliphatic or aromatic polyether-ester polyols, and polyols obtained from vegetable derivatives may be used. Accordingly, various combinations of polyols may be used to form the isocyanate-reactive component.

The isocyanate component may include isocyanate-containing reactants that are aliphatic, cycloaliphatic, alicyclic, arylaliphatic, and/or aromatic polyisocyanates and derivatives thereof. Derivatives may include, by way of example and not limitation, allophanate, biuret, and NCO-terminated prepolymers. According to some embodiments, the isocyanate component includes at least one aromatic isocyanate (e.g., at least one aromatic polyisocyanate). For example, the isocyanate component may include aromatic diisocyanates such as at least one isomer of toluene diisocyanate (TDI), crude TDI, at least one isomer of diphenyl methylene diisocyanate (MDI), crude MDI, and/or higher functional methylene polyphenol polyisocyanate. As used herein, MDI refers to polyisocyanates selected from diphenylmethane diisocyanate isomers, polyphenyl methylene polyisocyanates, and derivatives thereof bearing at least two isocyanate groups. The crude, polymeric, or pure MDI may be reacted with polyols or polyamines to yield modified MDI. Blends of polymeric and monomeric MDI may also be used. In some embodiments, the MDI has an average of from 2 to 3.5 (e.g., from 2 to 3.2) isocyanate groups per molecule. Example isocyanate-containing reactants include those commercially available under the tradename VORANATE™ from The Dow Chemical Company (Midland, Mich.), such as VORANATE™ M229 PMDI isocyanate (a polymeric methylene diphenyl diisocyanate with an average of 2.7 isocyanate groups per molecule).

An isocyanate index for the high density polyurethane layer may be greater than 70, greater than 100, greater than 180, greater than 195, greater than 300, greater than 500, greater than 700, greater than 1,000, greater than 1,200, and/or greater than 1250. The isocyanate index may be less than 2,000. For example, in some embodiments, the isocyanate index may be from 100 to 1,500, from 180 to 1,000, from 250 to 500, etc. As used herein, “isocyanate index” is the number of equivalents of isocyanate-containing compound added per 100 theoretical equivalents of isocyanate-reactive compound. An isocyanate index of 100 corresponds to one isocyanate group per isocyanate-reactive hydrogen atom present, such as from water and the polyol composition. Isocyanate Index is represented by the equation: Isocyanate Index=(Eq NCO/Eq of active hydrogen)×100, wherein Eq NCO is the number of NCO functional groups in the polyisocyanate, and Eq of active hydrogen is the number of equivalent active hydrogen atoms. A higher isocyanate index indicates a higher amount of isocyanate-containing reactant. Without being bound by theory, a high isocyanate index is believed to lead to better thermal stability and reaction-to-fire behavior, including reduced smoke production.

In various embodiments, the functionality and equivalent weight (EW) of the polyols in the isocyanate-reactive component used to form the high density polyurethane layer may be selected depending on the isocyanate index. For example, for isocyanate index lower than 180, polyol reactants may be selected to include at least one polyol having a functionality not lower than 3 and, as an average for the overall isocyanate-reactive component to provide an equivalent weight (EW) not greater than 200. In some embodiments, polyols having a hydroxyl functionality not lower than 3.0 may be selected among polyether polyols obtained by alkoxylation of high functional initiators, such as glycerine, trimethylolpropane, sucrose, sorbitol, and toluenediamine. Rather, lower functionality polyols (e.g., functionality lower than 3) may be preferably used for formulations having an isocyanate index greater than 180. Polyols having a hydroxyl functionality lower than 3 and particularly suitable for higher index formulations may be preferably selected from among polyester polyols.

Other additives, such as chain extenders, cross-linkers, and the like may also be included. Example chain extenders include dipropylene glycol, tripropylene glycol, diethyleneglycol, polypropylene, and polyethylene glycol. In various embodiments, the high density polyurethane layer excludes a separately added physical co-blowing agent. As used herein, “physical blowing agents” are low-boiling liquids which volatilize under the reaction conditions to form the blowing gas. In some embodiments, the composition comprises a water scavenger. Examples of water scavengers may include VORATRON™ EG 711, commercially available from The Dow Chemical Company (Midland, Mich.).

A catalyst may also be included in the composition forming the high density polyurethane layer. Example catalysts that may comprise tertiary amines such as triethylenediamine, or organometallic compounds such as dibutyltin dilaurate. Example catalysts that may be used include trimerization catalysts, which promote reaction of isocyanate with itself, such as tris(dialkylaminoalkyl)-s-hexahydrotriazines (such as 1,3,5-tris(N,N-dimethylaminopropyl)-s-hexahydrotriazine, DABCO™ TMR 30, DABCO™ K-2097 (potassium acetate), DABCO™ K15 (potassium octoate), POLYCAT™ 41, POLYCAT™ 43, POLYCAT™ 46, DABCO™ TMR, DABCO™ TMR 31, tetraalkylammonium hydroxides (such as tetramethylammonium hydroxide), alkali metal hydroxides (such as sodium hydroxide), alkali metal alkoxides (such as sodium methoxide and potassium isopropoxide), and alkali metal salts of long-chain fatty acids having 10 to 20 carbon atoms (and in some embodiments, pendant hydroxyl groups).

The high density polyurethane layer may also include one or more additives. For example, in some embodiments, the high density polyurethane layer further includes at least one flame retardant. The flame retardant may be present in an amount from 1 wt % to 50 wt % (e.g., 1 wt % to 30 wt %, 1.5 wt % to 20 wt %, 1.5 wt % to 10 wt %, 1.5 wt % to 8 wt %, 2 wt % to 5 wt %, 2.5 wt % to 4 wt %, 2.5 wt % to 3.5 wt %, etc.), based on the total weight of the composition for forming the high density polyurethane layer. The flame retardant may be a solid or a liquid, and include a non-halogenated flame retardants, a halogenated flame retardant, or combinations thereof. Example flame retardants include, by way of example and not limitation, phosphorous compounds with or without halogens, nitrogen based compounds with or without halogens, chlorinated compounds, brominated compounds, and boron derivatives.

In various embodiments, the high density polyurethane layer contains a particulate solid. In particular embodiments, the particulate solid may be expandable graphite, calcium carbonate, melamine or aluminum trihydroxide. For example, the high density polyurethane layer may be formed from a dispersion of expandable graphite and/or melamine in a polyisocyanate-based polymer matrix, which includes polyurethanes and/or polyurethane/polyisocyanurates. Expandable graphite may be used, for example, to provide certain desirable reaction-to-fire properties to the high density polyurethane layer, enabling the high density polyurethane layer to function as a fire barrier layer. Expandable graphite (an intercalation compound of graphite also referred to as “exfoliating graphite”) is a particulate expandable under fire conditions. According to various embodiments, the expandable graphite may have a particle size from 200 μm to 300 μm. In embodiments, the expandable graphite may be capable of expansion to at least 200 times (for example, from 250 time to 350 times) its initial volume. The rate of expansion may be 275 cm^{3/}g to 400 cm^{3/}g. The expansion temperature may vary depending on the particular expandable graphite. In some embodiments, the expandable graphite begins its expansion at a temperature from about 160° C. to about 225° C. Suitable expandable graphites include those commercially available under the tradenames QUIMIDROGA™ Grade 250, NORD-MIN® KP 251 (from Nordmann Rassmann), and GHL Px95 HE (from LUH).

The amount of expandable graphite present per unit area of the panel is calculated based on layer thickness, layer density, and weight percent of expandable graphite in the high density polyurethane layer (expressed as weight percentage divided by 100) incorporated in the reactants:

Amount of expandable graphite per unit area=(wt % of expandable graphite to total components in high density polyurethane layer)/100×(density of high density polyurethane layer)×(thickness of fire barrier layer)

It is believed that the amount of expandable graphite per unit area determines the attainable expansion of the layer and the extent of fire protection. In various embodiments, the amount of expandable graphite per unit area is at least 50 g/m², at least 200 g/m², at least 300 g/m², at least 340 g/m², at least 500 g/m², at least 600 g/m², at least 750 g/m², at least 800 g/m², at least 900 g/m², or at least 1,000 g/m². For example the amount of expandable graphite per unit area may be from 70 g/m² to 1,500 g/m², from 150 g/m² to 1,500 g/m², from 200 g/m² to 1,400 g/m², from 250 g/m² to 1,200 g/m², from 300 g/m² to 1,100 g/m², from 500 g/m² to 1,250 g/m², from 700 g/m² to 1,200 g/m², from 750 g/m² to 1,100 g/m², from 850 g/m² to 1,100 g/m², or the like.

In various embodiments, the high density polyurethane layer may contain an inorganic filler. The inorganic filler may contribute to stiffness and reduce dimensional changes upon temperature variations, due to the lower CLTE (Coefficient of Linear Thermal Expansion). Inorganic fillers may help for adhesion to mineral-based coat. Specific “ceramifying” compositions may decompose and undergo chemical reaction under fire conditions to form porous, coherent, and self-supporting ceramic products that positively contribute to the reaction-to-fire of the thermal insulation product. Example of ceramifying mixtures of inorganic compounds includes silicate minerals and fluxing agents such as inorganic phosphates or glass frits. The presence of inorganic fillers may also help for ease of machining and, in some cases, may also be effective in reducing cost.

In various embodiments, the high density polyurethane layer has a density of at least 100 kg/m³. For example, the high density polyurethane layer may have a density of from 100 kg/m³ to 2000 kg/m³, from 150 kg/m³ to 1200 kg/m³, from 175 kg/m³ to 800 kg/m³, or from 225 kg/m³ to 600 kg/m³.

The high density polyurethane layer may have a thickness from 0.5 mm to 30 mm. For example, the high density polyurethane layer may have a thickness from 1 mm to 25 mm, from 1 mm to 20 mm, from 1 mm to 15 mm, from 1 mm to 10 mm, from 1 mm to 5 mm, or the like. The high density polyurethane layer may be rigid or semi-rigid, but in various embodiments, the high density polyurethane layer is not brittle.

The high density polyurethane layer may be formed by reacting the isocyanate-reactive component with the isocyanate-containing reactant to form a polymer matrix, along with any additives that may include expandable graphite or any other suitable filler. Various methods may be used for introducing the expandable graphite or other solid particulate into the reaction mixture. For example, the expandable graphite or other solid particulate may be separately provided directly to the reaction mixture and/or may be provided in the isocyanate-containing component or the isocyanate-reactive component. As but one example, the expandable graphite may be pre-mixed with the isocyanate-reactive component (e.g., in an amount from 5 wt % to 50 wt %, 10 wt % to 45 wt %, 25 wt % to 45 wt %, 30 wt % to 40 wt %, 35 wt % to 40 wt %, etc.) based on the total weight of the resultant mixture that includes the isocyanate-reactive component, the expandable graphite, and optionally, other additives. Additionally or alternatively, the expandable graphite may be mixed with the isocyanate-containing component. The expandable graphite may be additionally or alternatively dispersed at a high concentration into a carrier that is introduced into the reaction mixture, or introduced directly into the reaction mixture as a solid that is then dispersed in the liquid reaction mixture.

### Polyurethane Based Foam

The polyurethane formulation for forming the rigid polyurethane foams 204 may be prepared from a multi-component system which relies on the formation of polyurethane polymers that are the reaction product of an isocyanate moiety provided from an isocyanate component with an isocyanate-reactive moiety provided from an isocyanate-reactive component to form polyurethane polymers. The resultant polyurethane based foam has an applied density from 25 kg/m³ to 75 kg/m³ (e.g., 30 kg/m³ to 70 kg/m³, 30 kg/m³ to 50 kg/m³, 35 kg/m³ to 45 kg/m³, etc.) according to ASTM D-1622.

For example, the polyurethane based foam may have a thermal conductivity value (λ) of less than 0.030 W/mK, less than 0.026 W/mK, or less than 0.024 W/mK.

The polyurethane based foam may be a blown rigid polyurethane foam. Processes for preparing blown rigid polyurethane compositions would be known to a person of ordinary skill in the art. For example, the blown rigid polyurethane foam may be prepared using a physical co-blowing agent, as will be described in greater detail below.

Polyurethane based foams, such as rigid polyurethane foams, contain urethane moieties and are made by starting materials that include an isocyanate component and an isocyanate-reactive component. In various embodiments, the composition for forming the polyurethane based foam may be prepared using a multi-component system. In the multi-component system, the isocyanate component and the isocyanate-reactive component are provided separately, and after mixing of the separate components the polyurethane foam may begin to form.

The isocyanate component includes at least one isocyanate (e.g., a polyisocyanate and/or an isocyanate-terminated prepolymer). The isocyanate-reactive component includes at least a polyol component that includes one or more polyols. The reaction mixture may include an optional additive component that includes at least one optional additive (such as a blowing agent, a catalyst, a curative agent, a chain extender, a flame retardant, a viscosity modifier, a filler, a pigment, a stabilizer, a surfactant, a plasticizer, and/or other additives that modify properties of the resultant final polyurethane product).

In exemplary embodiments, a multi-component system includes an isocyanate component having one or more polyisocyanates and/or one or more of the isocyanate-terminated prepolymers. For example, the multi-component system may include from 10 wt % to 95 wt % (e.g., 20 wt % to 90 wt %, 40 wt % to 85 wt %, 45 wt % to 75 wt %, 45 wt % to 65 wt %, 45 wt % to 55 wt %, 49 wt % to 55 wt %, etc.) of the polyisocyanate, based on a total weight of the composition for forming the polyurethane foam.

Exemplary polyisocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based foams. Examples include modified isocyanates, such as derivatives that contain biuret, urea, carbodiimide, allophanate and/or isocyanurate groups may also be used. Exemplary available isocyanate based products include PAPI™ products, ISONATE™ products, VORANATE™ products, and VORASTAR™ products, available from The Dow Chemical Company.

The polyol component of the isocyanate-reactive component for forming the polyurethane based foam may include one or more polyols. The polyol component may include one or more polyols selected from the group of a polyether polyol, a polyester polyol, a polycarbonate polyol, a natural-oil derived polyol, and/or a simple polyol (such as glycerin, ethylene glycol, propylene glycol, and butylene glycol). For example, the one or more polyols may include one or more polyether polyols and/or one or more polyester polyols. The polyether polyols may be prepared, e.g., by the polymerization of epoxides, such as ethylene oxide, propylene oxide, and/or butylene oxide. The polyester polyol may be the reaction product of aromatic dicarboxylic acids and/or their derivatives with hydroxylated compounds such as diethylene glycol, polyethylene glycols, or glycerine. The one or more polyols may have a hydroxyl number from 50 mg KOH/g to 550 mg KOH/g (e.g., 100 to 550 mg KOH/g).

The isocyanate-reactive component may be reacted with the isocyanate component at an isocyanate index from 70 to 600 (e.g., 80 to 400, 90 to 350, 90 to 250, 90 to 200, 100 to 170, etc.). The isocyanate index is measured as the equivalents of isocyanate in the reaction mixture for forming the polyurethane network, divided by the total equivalents of isocyanate-reactive hydrogen containing materials in the reaction mixture, multiplied by 100. Considered in another way, the isocyanate index is the ratio of isocyanate-groups over isocyanate-reactive hydrogen atoms present in the reaction mixture, given as a percentage.

The optional chain extender component may include a chain extender, e.g., that has two isocyanate-reactive groups per molecule and may have an equivalent weight per isocyanate-reactive group of less than 400. The optional crosslinker component may include at least one crosslinker that has three or more isocyanate-reactive groups per molecule and an equivalent weight per isocyanate-reactive group of less than 400.

The additive component may include one or more physical blowing agents. As used herein, “physical blowing agents” are low-boiling liquids which volatilize under the reaction conditions to form the blowing gas. Exemplary physical blowing agents include hydrocarbons, fluorocarbons, hydrofluorocarbons, hydrofluoroolefins, hydrochlorofluoroolefins, and other halogenated compounds.

The additive component may include one or more catalysts. For example, the additive component may include an amine, an organometallic, or a trimerization catalyst. For example, the catalyst component may account for less than 5.0 wt % of a total weight of the isocyanate-reactive component.

The polyurethane based foam may also include one or more fire retardants. The flame retardant may be present in an amount from 1 wt % to 50 wt % (e.g., 1 wt % to 30 wt %, 1.5 wt % to 20 wt %, 1.5 wt % to 10 wt %, 1.5 wt % to 8 wt %, 2 wt % to 5 wt %, 2.5 wt % to 4 wt %, 2.5 wt % to 3.5 wt %, etc.), based on the total weight of the composition for forming the polyurethane based foam. The flame retardant may be a solid or a liquid, and include a non-halogenated flame retardants, a halogenated flame retardant, or combinations thereof. Example flame retardants include, by way of example and not limitation, phosphorous compounds with or without halogens, nitrogen based compounds with or without halogens, chlorinated compounds, brominated compounds, and boron derivatives.

Various other additives, e.g., those known to those skilled in the art, may be included. For example, coloring agents, surface-active substances, extenders and/or plasticizers may be used. Dyes and/or pigments (such as titanium dioxide and/or carbon black), may be included in the optional additive component to impart color properties to the polyurethane foam. Pigments may be in the form of solids or the solids may be pre-dispersed in a polyol carrier. Reinforcements (e.g., flake or milled glass and/or fumed silica), may be used to impart certain properties. Other additives include, e.g., UV stabilizers, antioxidants, air release agents, and adhesion promoters, which may be independently used depending on the desired characteristics of the polyurethane foam.

The additive component and/or the polyurethane formulation may include or exclude any organic and inorganic solid fillers known in the art for use in rigid polyurethane foams. The solid fillers may be reinforcing fillers. According to some embodiments, the rigid polyurethane foam layer has a reinforced structure due to the presence of one or more glass fiber mats. Preferred glass fiber mats are of the type commonly known as expandable, that due to the low binder content of the glass fiber mat, separate under the influence of the expanding foam in such a manner as to be evenly distributed throughout the foam in planes substantially parallel to the plane of the facing sheets. Suitable glass fiber mats may have a weight per unit area of 20 g/m² to 200 g/m², 30 g/m² to 100 g/m², more preferably about 70 g/m². Depending on the foam layer thickness one or more glass-fiber mats may be used.

The polyurethane foam may be formed by a spraying and/or pouring application that applies the polyurethane system on a base substrate and/or a surface. The spraying and/or pouring application may be done on a conveyor device, e.g., in a continuous manner.

### Facing Layer

As provided above, in some embodiments, the insulation component 106 may further include at least one facing layer. In embodiments, the facing layer may be positioned adjacent to the rigid polyurethane foam layer or to the high density layer or to both. Accordingly, in some embodiments, the high density polyurethane layer 202 is not in contact with a facing layer.

In various embodiments, the facing layer is a non-metal based facing layer, such as a glass-fleece based material. As used herein, “glass-fleece based material” refers to a material that includes glass fleece, such as a glass-fleece substrate.

In some embodiments, a second facer layer may be included on the insulation component 106 on the opposite face from the first facing layer. The first and second facing layers may be made the same or different materials. In other words, the material of the first and second facing layers may be independently selected from glass based material that includes glass fleece and polymer membrane based material. Each facing layer may independently have a thickness from 0.01 mm to 3 mm (e.g., 0.05 to 0.6 mm, 0.05 to 0.1 mm, 0.07 to 0.09 mm, etc.). According to one particular embodiment, the first facing layer may be made of the same material and have the same thickness as the second facing layer.

Example materials suitable for use as facing layers include, for example glass-fleece or glass tissues that may be mineral or bituminous coated. In various embodiments, the glass-fleece may meet requirements for Euroclass C classification.

Alternatively, in some embodiments, the insulation component 106 may have a peel-able facing layer in contact with the high density polyurethane layer 202. In such embodiments, the peel-able facing layer may be removed from the insulation component 106 before the insulation component 106 is used. Examples of peel-able facings include polyolefin films (such as, but not limited to, propylene and polyethylene), polyhalogenated polyolefins, waxed paper and waxed plastic films, plastic and composite foils. The removable film may be peeled off while the board travels out of the continuous fabrication process or removed at the time of use. The high density layer, once the peel-able film is removed, allows further processing such as to machine to provide a rough surface and/or troughs across at least part of the thickness to help reduce stresses and/or help interlocking with other materials once installed. In certain other embodiments, the peel-able facings are removed just before use. In such embodiments, the removable facings are preferably selected among diffusion proof foils to preserve the thermal insulation value as long as possible before use.

In various embodiments, at least one of the polyurethane based foam and the high density polyurethane layer may be formed on the facing layer. For example, the polyurethane based foam or the high density polyurethane layer may be formed on a surface of the facing layer by application of a liquid reaction mixture to the facing.

In one particular embodiment, the high density polyurethane layer may be formed on a facing layer by applying a liquid reaction mixture to the facing layer. After a delay to allow the high density polyurethane layer to at least partially cure, the liquid reaction mixture for the polyurethane foam may be applied to the high density polyurethane layer. In some embodiments, the delay may be 10 seconds or more. In some embodiments, one or more glass fiber mats are laid down to provide foam structure reinforcement. An additional facing layer may be applied to the polyurethane foam. In embodiments in which the insulation component has high density polyurethane layers on both opposing sides of the polyurethane foam layer, the insulation component may be produced by pouring or spraying a second high density polyurethane forming composition on the inner face of the second facing.

Alternative processes are contemplated that may not involve the laying the high density polyurethane layer on a facing layer. Exemplary alternative processes may involve the step of spraying or pouring the reaction mixture for forming the high density polyurethane layer on a bed of sand or any other suitable particulate. The high density polyurethane layer formed in contact with the bed would achieve a roughened surface due to the inclusion of sand. Without being limited by theory, this roughened surface may advantageously provide strong adhesion between the insulation component and the rendering system.

### Procedures and Test Methods

### Pull Through Test

The test was carried out measuring the force required to pull a screw out of the sample. Each sample was 35 mm×80 mm×50 mm (thickness). The screw had a diameter of 5.25 mm and a screwing depth of 25 mm. The screw was pulled out at a speed of 5 mm/minute. The cell load was 10 kN. There were 5 specimens per analysis.

### Reaction to Fire

The reaction to fire was carried out according to the Euroclassification system (EN13501-1), in which main classifications go from F to A. There are additional classifications for smoke (s3, s2 or s1) and dripping (d2, d1, d0). Combustible materials are tested with two methods: the ignitability test (EN11925-2) and an intermediate scale corner test (EN13823, known as SBI). The former is used to measure the flame height of a small vertical specimen. The latter is used to measure the heat release and smoke production. Requirements to meet the Euroclasses available for combustible materials are described in Table 1. Mounting and fixing of the test assembly for SBI has been done with one vertical and one horizontal joint in the long wing, according to EN15715. Testing with a vertical and a horizontal joint in the same test reflects a worst case situation and gives the widest field of application.

TABLE 1
Table 1: Reaction-to-Fire Criteria For Euroclass
Classification According to EN 13501-1

| | | Classification Criteria | Classification Criteria |
|---|---|---|---|
| | | for Test Method | for Test Method |
| Class | Parameters | EN 13823 | EN 11925-2 |
| B | FIGRA: fire growth rate index | FIGRA ≤ 120 W/s | Ignition time: 30 seconds; |
| | THR: total heat release | THR ≤ 7.5 MJ | Flame height < 150 mm |
| | LFS: lateral flame spread | LFS < edge of specimen | within 60 seconds |
| C | SMOGRA: smoke growth rate | FIGRA ≤ 250 W/s | |
| | index | THR ≤ 15 MJ | |
| | TSP: total smoke production | LFS < edge of specimen | |
| | FDP: flaming droplets or particles | | |
| D | | FIGRA ≤ 750 W/s | |
| E | | — | Ignition time: 15 seconds; |
| | | | Flame height < 150 mm |
| | | | within 20 seconds |

### EXAMPLES

The following examples are provided to illustrate various embodiments, but are not intended to limit the scope of the claims. All parts and percentages are by weight unless otherwise indicated. Approximate properties, characters, parameters, etc., are provided below with respect to various working examples, comparative examples, and the materials used in the working and comparative examples. Further, a description of the raw materials used in the examples is as follows:

Polyol A is a polyol mixture of i) 63.3 pbw of terephtalic acid based polyester polyol having OH number 215 and functionality 2, ii) 21 pbw of terephtalic acid based polyester polyol having OH number 315 and functionality 2.4, iii) 15.7 pbw of trichloroisopropylphosphate, iv) 0.80 pbw of water, v) 4 pbw of polysiloxane/polyether copolymers surfactant, vi) 1 pbw of POLYCAT™ 5, and vii) 1.2 pbw of DABCO™ TMR7 catalyst.

Polyol B is a polyol mixture of i) 58 pbw of a terephtalic polyester polyol having OH number 215 and functionality 2, ii) 15 pbw of a polyethylene glycol having 400 MW, iii) 15 pbw of trichloroisopropylphosphate, iv) 6.5 pbw of triethylphosphate, v) 3 pbw of polysiloxane/polyether copolymers surfactant, and vi) 1.5 pbw of DABCO™ TMR 31 catalyst. VORATHERM™ CN 626 is a catalyst available from The Dow Chemical Company (Midland, Mich.).

VORANATE™ M 220 is polymeric methylene diphenyl di-isocyanate (PMDI), available from The Dow Chemical Company (Midland, Mich.);

VORANATE™ M 600 is polymeric methylene diphenyl di-isocyanate (PMDI), available from The Dow Chemical Company (Midland, Mich.);

DABCO™ TMR7 is a trimerization catalyst available from Evonik;

DABCO™ TMR31 is a catalyst available from Evonik;

OMYACARB™ SUM is calcium carbonate, available from Omya, Inc. (Proctor, Vt.);

GHL Px95 HE is expandable graphite, available from Georg H. Luh GmbH (Germany);

POLYCAT™ 5 is a pentamethyl diethylene triamine catalyst available from Air Products and Chemicals Inc.;

BYK W 969 is a wetting and dispersing additive available from Byk; and

VORATRON™ EG711 ADDITIVE is a 50% mixture of zeolite in castor oil, available from The Dow Chemical Company (Midland, Mich.).

The high density polyurethane layer is prepared according to the formulation in Table 2.

TABLE 2
Table 2: Formulation of High Density
Polyurethane Layer

Parts by Weight

Isocyanate-reactive Component

| | |
|---|---|
| Polyol B | 99 |
| BYK 969W | 1 |
| VORATRON ™ EG | 2 |
| 711 ADDITIVE | |

Filler

| | |
|---|---|
| OMYACARB ™ 5UM | 77 |
| PX95HE | 38 |

Catalyst

| | |
|---|---|
| VORATHERM ™ CN | 0.4 |
| 626 | |

Isocyanate Component

| | |
|---|---|
| VORANATE ™ M 220 | 151 |
| (PMDI) | |

The rigid polyurethane foam is prepared according to the formulation provided in Table 3.

TABLE 3
Table 3: Formulation of
Rigid Polyurethane Foam

Parts by Weight

Isocyanate-reactive Component

| | |
|---|---|
| Polyol A | 105.8 |
| Blowing Agent | 22.8 |

Isocyanate Component

| | |
|---|---|
| VORANATE ™ M 600 | 260 |

The blowing agent in Table 3 is a mixture of 70 wt % of cyclopentane and 30 wt % of iso-pentane.

Example 1 included a high density polyurethane/polyisocyanurate layer is prepared according to the formulation in Table 2, a rigid polyurethane/polyisocyanurate foam is prepared according to the formulation provided in Table 3, and a facing layer of STONEGLASS™ 300, commercially available from Silcart (Italy). The high density polyurethane/polyisocyanurate layer was prepared by dispensing the high density polyurethane layer composition over the facing layer. The high density polyurethane layer and the rigid polyurethane foam were prepared on a double band laminator on a continuous line. The high density polyurethane layer had a density of 530 kg/m³ and was 4.5 mm thick and the rigid polyurethane foam had a density of 32 kg/m³ and was 95.5 mm thick. The total board thickness was 100 mm and includes facings on both sides.

Example 2 included a high density polyurethane layer is prepared according to the formulation in Table 2 and a rigid polyurethane foam is prepared according to the formulation provided in Table 3. Example 2 was prepared according to the method used for Example 1, but did not include a facing layer. Specifically, the facing layer was removed from the side of the high density polyurethane layer after formation of the board. The high density polyurethane layer was 4.5 mm thick and the rigid polyurethane foam was 95.5 mm thick. The total board thickness was 100 mm.

Comparative Example A included a rigid polyurethane/polyisocyanurate foam is prepared according to the formulation provided in Table 3. The rigid polyurethane/polyisocyanurate foam was prepared on a double band laminator on a continuous line in the same manner as Examples 1 and 2, but did not include a high density polyurethane layer. Accordingly, the amount of the rigid polyurethane/polyisocyanurate foam reaction mixture was adjust to provide a rigid polyurethane/polyisocyanurate foam with a thickness of 100 mm.

Comparative Example A and Examples 1 and 2 were tested for reaction to fire and subjected to a pull through test to determine maximum stress. Flame height was measured according to EN ISO 11925-2. SBI Tests were not conducted on Example 2. For Examples 1 and 2, the specimen was oriented with the high density polyurethane layer oriented toward the flame impingement. The results are reported in Table 4.

TABLE 4
Test Results for Comparative Example A and Examples 1 and 2

| | Comparative | | | | | |
|---|---|---|---|---|---|---|
| | Example A | | Example 1 | | Example 2 | |
| Max stress | 34.7 ± 9.7 | | 308.5 ± 6.8 | | 312.2 ± 9.7 | |
| (N/mm²) | | | | | | |
| Flame height | 8-9 | | 4-5 | | 2-2.5 | |
| accordingly to | | | | | | |
| EN11925-2 | | | | | | |
| (cm) | | | | | | |
| SBI Test | 1 | 2 | 1 | 2 | 1 | 2 |
| FIGRA | 1281.6 | 1226.3 | 236.0 | 200.0 | N/A | N/A |
| 0.2 MJ/0.4 MJ | | | | | | |
| (W/s) | | | | | | |
| THR (MJ) | 14.7 | 14.2 | 12.2 | 12.2 | N/A | N/A |
| SMOGRA | 175.6 | 143.9 | 29.7 | 25.3 | N/A | N/A |
| (m²/s²) | | | | | | |
| TSP (m²) | 167 | 129.8 | 193.8 | 148.8 | N/A | N/A |

Referring to Examples 1 and 2 and Comparative Example A, Examples 1 and 2, which included the high density polyurethane layer, showed increased strength for mechanical fixing as compared to Comparative Example A.

For the reaction to fire, Examples 1 and 2 exhibited improved flame height according to EN11925-2 both with and without the facing layer. The improvement in reaction to fire was confirmed by the heat release parameters (FIGRA and THR) in the SBI test performed on Example 1 and Comparative Example A. In particular, Comparative Example A resulted in a Euroclass E classification, whereas Example 1 resulted in a Euroclass C classification.

The thermal insulation of the boards of Example 1 and Comparative Example A was measured by means of a LaserComp heat flow meter instrument. The boards were cut in the middle of the thickness obtaining two halves. For Comparative Example A, each of the two halves included the facer and part of the thickness of the insulating foam. For Example 1, one half included the facer, the high density layer, and part of the thickness of the foam, the other the facer and part of the thickness of the foam. The specimen dimensions were 200 mm×200 mm×25 mm (thickness). The thermal conductivity values measured at 10° C. were 0.0230 and 0.0227 W/mK for Comparative Example A and 0.0227 and 0.0267 W/mK for Example 1, respectively, for the half without and the half with the high density layer. The thermal resistance (R-value) was then calculated as 4.37 and 4.24 m²K/W, respectively, for Comparative Example A and Example 1. The R-value of Example 1, while slightly lower than the Comparative Example A, was by far better than conventional insulation products used for ETICS applications such as EPS, grey EPS or mineral wool whose R values for same thickness range between 2.5 and 3.1 m²K/W.

Various embodiments described herein exhibit improved reaction to fire performance while providing improved insulation as compared to conventional thermal insulation products. Accordingly, various embodiments described herein may be employed in external thermal insulation composite systems where improved insulation, fixing strength, and reaction to fire performance is desired.

It is further noted that terms like “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. An external thermal insulation composite system, comprising:
(i) a concrete or masonry wall;
(ii) a multilayer thermal insulation board on the concrete or masonry wall, the multilayer thermal insulation board including a high density polyurethane layer having a first density from 100 kg/m³ to 2000 kg/m³ according to ASTM D 1622 and a rigid polyurethane foam having a second density of less than 100 kg/m³ according to ASTM D 1622.

2. The external thermal insulation composite system as claimed in claim 1, wherein the high density polyurethane layer is the reaction product of a first reaction mixture that includes at least a first isocyanate component, a first isocyanate-reactive component, optionally a first flame retardant, and optionally a filler.

3. The external thermal insulation composite system as claimed in claim 2, wherein the first mixture excludes added physical blowing agent.

4. The external thermal insulation composite system as claimed in claim 1, wherein the rigid polyurethane foam is the reaction product of a second reaction mixture that includes at least a second isocyanate component, a second isocyanate-reactive component, and a physical blowing agent.

5. The external thermal insulation composite system as claimed in claim 1, wherein the high density polyurethane layer is adhered to the rigid polyurethane foam.

6. The external thermal insulation composite system as claimed in claim 1, wherein the multilayered thermal insulation board further includes at least one facing layer selected from at least one of saturated glass-fleece and non-saturated glass-fleece.

7. The external thermal insulation composition system as claimed in claim 1, wherein the high density polyurethane layer is the reaction product of a first reaction mixture that includes at least a first isocyanate component, a first isocyanate-reactive component comprising one or more polyester polyols, and a first flame retardant.

8. The external thermal insulation composite system as claimed in claim 1, wherein the high density polyurethane layer comprises expandable graphite.

9. The external thermal insulation composite system as claimed in claim 1, wherein the rigid polyurethane foam is reinforced with a glass fiber mat.

10. A method of preparing an external thermal insulation composite system comprising:
providing a concrete or masonry wall;
providing a multilayered thermal insulation board that comprises a high density polyurethane layer having a density from 100 kg/m³ to 2000 kg/m³ and a rigid polyurethane foam layer having a density less than 100 kg/m³;
attaching the multilayered thermal insulation board to an external surface of the concrete or masonry wall using an adhesive or mechanical fixing device; and
applying a reinforced coating with embedded glass fiber mesh reinforcement on the multilayered thermal insulation board attached to the external surface of the concrete or masonry wall.

11. The method as claimed in claim 10, wherein the multilayered thermal insulation board is prepared according to a continuous process comprising:
providing a first facing as a lowermost layer;
dispensing a first reaction mixture to form the at least one high density polyurethane layer on a surface of the first facing;
dispensing a second reaction mixture to form the rigid polyurethane foam layer on the forming high density polyurethane layer;
providing a second facing layer on the rigid foam polyurethane layer as an uppermost layer; and
allowing the multilayered thermal insulation board to cure between two spaced apart, opposed forming conveyors.

12. The method as claimed in claim 11, wherein the first facing is a removable film.

13. The method as claimed in claim 12, wherein the removable film is removed after production and the multilayered thermal insulation board is further processed by machining to provide a rough surface and/or troughs across at least part of the thickness of the high density polyurethane layer.

14. The method as claimed in claim 11, wherein the first reaction mixture includes at least a first isocyanate component, a first isocyanate-reactive component, optionally a first flame retardant, and optionally a filler.

15. The method as claimed in claim 11, wherein the second mixture includes at least a second isocyanate component, a second isocyanate-reactive component, and a physical blowing agent.
